(19) United States
(12) Patent Application Publication
(10) Pub. No.: US 2010/0101527 A1
(43) Pub. Date: Apr. 29, 2010

(54) LOAD-OPTIMIZED INTERIOR OF A PISTON

(75) Inventor: Volker Gniesmer, Alfeld (DE)

Correspondence Address: YOUNG BASILE, 3001 WEST BIG BEAVER ROAD, SUITE 624, TROY, MI, 48084, US

(73) Assignee: KS KOLBENSCHMIDT GMBH, Neckarsulm (DE)

(21) Appl. No.: 12/531,753

(22) PCT Filed: Mar. 22, 2008
(86) PCT No.: PCT/EP08/02323

§ 371 Date: Sep. 17, 2009

(30) Foreign Application Priority Data
Apr. 21, 2007 (DE) 10 2007 018 932.1

(51) Int. Cl. F02F 3/00; F16J 1/14

(52) U.S. Cl. 123/193.6; 92/187

(57) ABSTRACT

A piston of an internal combustion engine has a piston crown provided with a ring zone and adjoining a piston skirt encompassing a piston interior, the skirt having two load-bearing skirt wall segments and two pin bosses. Each pin boss encompassing a boss hole is connected to a boss base body by a boss support, the base body having ribs to increase stiffness, which are aligned to the extent possible in the direction of the boss holes continuously connecting the pin bosses. The curved or arched ribs thereby cover a pivoting range of a connecting rod.

### BACKGROUND

The invention relates to a piston of an internal combustion engine having a piston crown provided with a ring zone and adjoining a piston skirt that forms two diametrically opposed load-bearing piston skirt sections and two pin bosses offset thereto that together encompass a piston interior.

Internal combustion engines that are more highly stressed, with increased specific outputs and reduced fuel consumption, require low reciprocating masses and therefore optimized pistons, without limiting their service life. It is known to provide such pistons with stiffening ribs in order to achieve sufficient durability. The stiffening ribs intended to achieve increased component strength are preferably designed with uniform dimensions. The known ribs are disposed in the piston interior spaced apart from the circumferential surface of the piston skirt and thus rotationally symmetrical to a vertical axis of the piston. It has been shown that stiffening ribs with proximately uniform wall thickness disposed in this manner do not provide adequate component stiffness for more highly stressed pistons.

Thus, it would be desirable to improve the geometric stiffness of the piston with specific, economically demonstrable measures.

### SUMMARY

In accordance with the invention, the piston interior encompasses, to the extent possible ribs, aligned in the direction of the boss holes, the ribs being connected in one piece to the boss base body or the piston crown and creating a continuous connection between the pin bosses. The ribs effectively stiffening the pistons are curved facing away from a pin axis, or shaped like a bridge. The dimensioning, the height, the rib thickness and the shape of the ribs are carried out in accordance with the invention such that the ribs provide clearance for a connecting rod and thus take account of a pivoting range of a connecting rod small end.

The ribs connecting the pin bosses optimize the transmission, or the redirection, of force inside the piston from the piston crown into the pin bosses. The design concept in accordance with the invention can be implemented economically and, by means of a local, relatively small stiffening section between the pin bosses forms an advantageously load-optimized piston interior that simultaneously results in improved geometric stiffness of the piston. These measures are particularly suited to a weight-optimized piston to achieve improved component stiffness. The service life of the piston can be advantageously increased with the ribs and, at the same time, the incidence of damage can be reduced. The stiffening measures can be transferred to both forged or welded steel pistons and also to case pistons. The piston configured in accordance with the invention is preferably suited for application in performance-enhanced, mechanically highly stressed internal combustion engines, specifically diesel internal combustion engines.

One design in accordance with the invention for a welded cooling channel piston provides for a congruity in position between the ribs and a piston crown wall separating cooling channels that is supported by a connecting web at a connecting web of the boss base body. The result is an advantageously improved transfer of force originating from the piston crown through the connecting webs and ribs into the pin bosses.

Further provision is made for shaping the ribs on the side facing away from the piston crown to be arcuate. Starting from the pin bosses, the result is an overall rib height that decreases continuously to a crown line of the ribs. This contour, also forming an arched shape, can be advantageously adapted to a stress patter that is the result of the force transferred into the piston. As a supplement, or alternative, thereto, provision is additionally made in accordance with the invention for the ribs to become stronger or thicker in the direction of the pin boss.

A further aspect of the invention comprises a proximately oval-shaped zone or recess in the area of the piston crown. In order to implement this solution, the ribs form an arcuate connection between the pin bosses and thus delimit the recess. The shape and the overall height of the ribs cover the pivoting range of the small end of the connecting rod.

The invention encompasses diverse geometric shapes for the ribs that can be selected solely from the viewpoint of optimal strength of the piston interior shape. A rib with a rounded, specifically half-round cross-sectional profile, suggest itself. Furthermore, the rib can have differently shaped outer contours. A convexly or concavely shaped outer contour for the rib is particularly suitable. Likewise, an outer contour running in a straight line can be provided. The outer contour can diverge from the inner contour of the rib, for example as the result of radii with different curvatures, or an outer contour running to the extent possible in a straight line or concavely that is allocated to a rounded line of the inner contour.

To achieve proximately stress-free transitions between the ribs and the pin bosses, or the boss supports respectively, rounded transition zones, or rounded transitions, are provided. The resulting radii between the outer contour and the inner contour or the one part of the pin boss on the other part are identical, disposed diverging from each other or running counter to each other.

A rib contour of convex configuration and rounded toward the outside can run between the pin bosses, preferably in a radius “R” which corresponds to ≧50% of a radius “h” of the piston. The associated inner contour of the rib advantageously runs in a radius “r”, which corresponds to ≧20% of the piston radius. The rib is furthermore designed such that a distance “c” results between the axis “x-x” and the crown line of the inner contour, which differs from the radius “r”, preferably the dimension “c” exceeds the radius “r”. The further layout of the rib additional provides for the radius “R” that defines the outer radius to differ from the dimension “d” that results between the axis “x-x” and the crown line of the outer contour.

For a friction-welded piston, the rib or ribs can be located in such a way that a congruity of position exists at least in areas between the rib and a connecting web joined by means of friction welding, by which a piston upper part and piston lower part, or a boss base body, are supported. The rib—at least a thickening of the friction weld in some areas—can thereby be used to advantageously thicken the friction weld area.

### BRIEF DESCRIPTION OF THE INVENTION

In order to clarify the invention, aspects of the invention are explained in what follows.

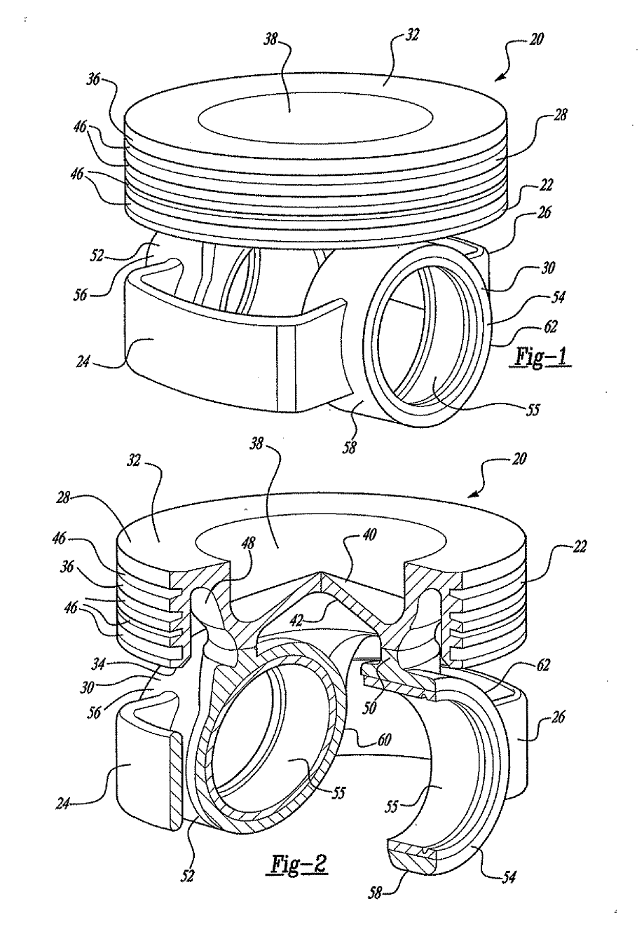

FIG. 1 shows a piston in longitudinal section with a rib between the pin bosses in accordance with the invention;

FIG. 2 shows a piston in longitudinal section rotated by 90° compared with FIG. 1;

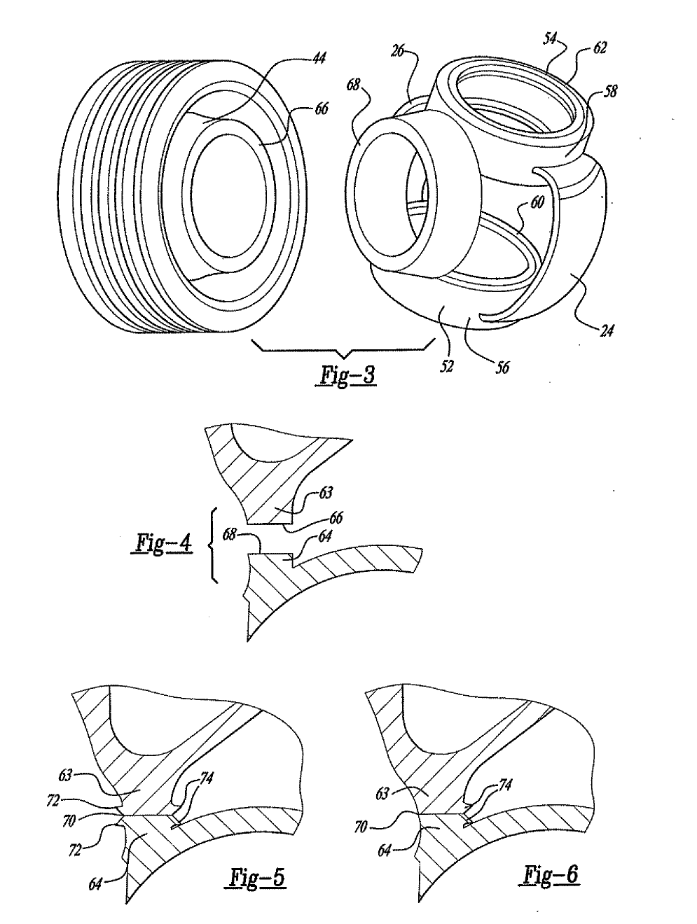

FIG. 3 shows the piston from FIGS. 1 and 2 in a view onto the piston crown;

FIG. 4 shows a piston in a view onto the piston crown, wherein the rib has an outer contour running convexly; and

FIG. 5 shows a view of a piston comparable to FIG. 4 in which the rib has an outer contour running in a straight line.

### DETAILED DESCRIPTION

The piston 1 shown in FIG. 1 is fashioned as a cooling-channel piston that comprises a piston crown 2 as a piston upper part and a piston skirt 3 as a piston lower part, where these components are supported by connecting webs 4a, 4b. In order to create one structural unit, at least the connecting webs 4a, 4b are friction welded and a material joint is created thereby, where the connecting webs 4a, 4b from weld beads 5a, 5b on both sides. The piston crown 2 has a combustion bowl 6 on its face and a top land 7 on its exterior adjoining a ring zone 8 to locate piston rings (not shown). Spaced apart from the ring 8, a first radially circumferential cooling channel 9 and a central cooling channel 10 are integrated in the piston 1 that, in the operating state, are contacted in common by a cooling medium. The piston skirt 3 immediately adjoining the right zone 4 encompasses two diametrically opposed skirt wall sections 11, and offset thereto, two pin bosses 12 with integral boss holes 13. The boss holes 13 are intended to receive a piston pin, not shown in FIG. 1, by which a connecting rod is articulated to the piston 1. Correspondingly, the pin bosses 12 are directly connected by boss supports 14 to a boss base body 15 that forms an intermediate plane to the piston crown 2. The pin bosses 12 are connected by two ribs 17 running arcuately and allocated to the boss base body 15 as an additional measure to improve the component strength of the piston 1. These ribs positioned in the piston interior 16 effect an improved transfer of force originating from the piston crown 2 over the ribs 4a, 4b, the web base body 15, the ribs 17 and the pin bosses 12 into the piston pin and from there into the connecting rod. Simultaneously, this measure improves the component strength of the piston 1, since the ribs 17 create an effective connection, positively affecting the structure stresses between the pin bosses 12. The rounded line of the rib 17, starting from a central crown line 18, extends arcuately on both sides to the pin bosses 12. A distance “a” thereby results between a pin axis 19 of the boss hole 13 and the rib 17 in the area of the crown line 18 that exceeds a dimension “b” between the pin axis 19 and the transitions of the rib 17 into the pin bosses 12.

FIG. 2 shows the piston 1 in accordance with FIG. 1 in a sectional view rotated by a 90° in which the two ribs located opposite to and offset from each other are shown. The ribs 17 allocated immediately to the boss base body 15 have a flattened, proximately half-round shaped cross-sectional profile, wherein rounded transitions to the boss base body 15 result. A congruity in position exists to the extent possible between the ribs 17 and the connecting webs 4a, 4b formed by circular annular walls of the piston crown 2 and of the boss base body 15. As a result, a local stiffening of the piston 1 in a zone between the pin bosses 12 is created. All additional details and components of the piston 1 correspond to the piston 1 shown in FIG. 1 and explained heretofore.

The piston 1 is shown in FIG. 3 in a view onto the piston interior 16. This representation makes clear the extension of the rib 17 at the boss base body 15 in a different view. In this view, the ribs 17 have a radially outward facing convex curvature. Each rib 17, starting from and delimited by the crown line 18, grows wider towards the pin bosses 12. Correspondingly, the radii “r”, “R” for an inner counter 20 and outer contour 21 of the ribs 17 are assigned to different foci on an axis “y-y”. The position of the ribs 17 is defined by distances “c” and “d” from the axis “x-x” to the crown line 18 of the inner contour 20 and of the outer contour 21 respectively that are set up and that correspond to a partial dimension of the piston radius “s”. The radius “r” determining the inner contour 20 of the rib 17 corresponds to ≧20% and the radius “R” determining the outer radius corresponds to ≧50% of the piston radius “s”. The design further provides that both the distance “c” differs from the radius “r” as does the distance “d” from the radius “R”. Furthermore, the rib 17 forms rounded transition zones 22 curved counter to the shape of the curved outer contour 21, which zones make possible an optimal connection and consequently an ideal transition of the rib 17 to the pin bosses 12.

FIGS. 4 and 5 shows ribs formed with alternate shapes to FIG. 3. In accordance with FIG. 4, the rib 23 encompasses a concave outer contour 24 to which is assigned an inner contour 20 running in a comparable way to the other rib shapes. The result is more pronounced narrowing of the rib in the area of the crown line 18. FIG. 5 shows a further variation configured in accordance with the invention, in which the rib 25 has an outer contour 26 running in a straight line in conjunction with an inner contour 20 from FIG. 1.

What is claimed:

1. A piston of an internal combustion engine having a piston crown provided with a ring zone adjoining which and encompassing a piston interior is a piston skirt with two load-bearing skirt wall sections and two pin bosses, where each pin boss includes a boss hole and is connected by a boss support to a boss base body that encompasses at least one rib to increase stiffness, comprising:
ribs aligned in the direction of the boss holes and continuously connecting the pin bosses, the ribs being of one of a curved and an arched shape facing away from a pin axis and covering a pivoting range of a connecting rod small end.

2. The piston of an internal combustion engine from claim 1, wherein the location of the ribs coincide with connecting webs by which a wall of the piston crown running annularly is supported on the boss base body.

3. The piston of an internal combustion engine from claim 1, wherein the ribs, starting from a pin axis, have an arcuate shape facing outward.

4. The piston of an internal combustion engine from claim 1, wherein the ribs, starting from a crown line, increase in thickness in the direction of the pin boss.

5. The piston of an internal combustion engine from claim 1, wherein the ribs between the pin bosses delimit a proximately oval-shaped zone on the boss base body for the connecting rod eye.

6. The piston of internal combustion engine from claim 1, wherein an outer contour of the ribs runs one of concavely and convexly.

7. The piston of an internal combustion engine from claim 1, wherein the outer contours of the spaced apart ribs are aligned straight and run proximately parallel to each other.

8. The piston of an internal combustion engine from claim 1, wherein at least one stiffening rib has a half-round cross-sectional profile.

9. The piston of an internal combustion engine from claim 1, wherein the outer contour at least one rib merges into one of the boss support and the pin bosses as it forms rounded transition zones.

10. The piston of an internal combustion engine from claim 1, wherein the inner contour of the ribs has a rounded transition to one of the pin boss or and the boss support.

11. The piston of an internal combustion engine from claim 1, wherein an inner contour of the rib runs in a radius “r” of ≧20% of a piston radius and an outer contour of the rib runs in a radius “R” of ≧50% of the piston radius.

12. The piston of an internal combustion engine from claim 11, wherein the position of the inner contour is determined by a distance “c” between the axis “x-x” and a crown line of the inner contour that exceeds the radius “r”.

13. The piston of an internal combustion engine from claim 11, wherein the position of the outer contour is determined by a distance “d” between an axis “x-x” and a crown line of the outer contour, where the radius “R” exceeds the dimension “d”.

14. The piston of an internal combustion engine from claim 1, wherein a congruity in position exists at least in one area between the ribs and the connecting webs that are joined by means of a friction weld.

15. The piston of an internal combustion engine from claim 14, wherein the ribs result in a thickening of the friction weld in at least one area.
